(19) United States
(12) Patent Application Publication
(10) Pub. No.: US 2016/0092798 A1
(43) Pub. Date: Mar. 31, 2016

(54) ONLINE MARKETPLACE FOR PURCHASING SHARED OR EXCLUSIVE HOTEL RESERVATIONS

(71) Applicant: ISHAREHOTEL, LLC

(72) Inventor: Sam Ikkurty, Tampa, FL (US)

(21) Appl. No.: 14/635,608

(22) Filed: Mar. 2, 2015

Related U.S. Application Data
(60) Provisional application No. 62/055,850, filed on Sep. 26, 2014.

(51) Int. Cl. G06Q 10/02

(52) U.S. Cl. CPC G06Q 10/02

(57) ABSTRACT

The present invention relates to generally to an online marketplace. More specifically, the invention relates to an online marketplace where individuals are able to list bookings or shared accommodation and accept offers at the listing individual's discretion.

### FIELD OF THE INVENTION

The present invention relates to generally to an online marketplace. More specifically, the invention relates to an online marketplace where individuals are able to list bookings or shared accommodation and accept offers at the listing individual's discretion.

### CROSS-REFERENCE TO RELATED APPLICATIONS

This application claims the benefit of U.S. Provisional Patent Application No. 62/055,850, filed on Sep. 26, 2014, which is hereby incorporated by reference in its entirety.

### BACKGROUND OF THE INVENTION

At the present time, travelers have several options for finding hotel rooms when traveling. travel sites, such as Expedia®, Travelocity®, Priceline®, Orbitz®, and more, give travelers access to hotel rates and availability as well as the ability to reserve the hotel room online. Travelers can sort through available listings by editing search parameters such as dates, city, hotel reviews, and other options. For the most part the deals offered on the sites are very similar. Prices for a hotel reservation at the same hotel, for the same type of room, and the same dates, have little variance between sites and in many situations are the same price.

In most situations, travel sites offer enough convenience for booking hotel rooms, yet there are instances where their services are lacking. Conventions, sporting events, and company outings reduce the hotel room availability within a particular area. In this situation, there are many individuals who work for the same company, are on the same team, or are attending the same convention that would not need an entire room to themselves, but are unable to share their room due to the limitations of travel sites. In this situation, sharing a room becomes mutually beneficial to both parties. Travelers willing to share their room can offset the cost of their hotel room while offering an available room at a reduced cost to another traveler who may have not found any accommodations in the immediate area.

Therefore, there is a need in the art for a system and method that provides travelers with a convenient and secure marketplace to list, sell, and share hotel reservations with other individuals. These and other features and advantages of the present invention will be explained and will become obvious to one skilled in the art through the summary of the invention that follows.

### SUMMARY OF THE INVENTION

Accordingly, embodiments of the present invention are directed to a system and method for conveniently and securely facilitating the listing, selling, and sharing of hotel reservations between individuals. In a preferred embodiment, travelers listing a reservation (Hosts) can use an online marketplace to sell their reservation for exclusive use by another traveler (Guest) or offer their reservation as a shared listing, where the Host shares the room with the Guest.

According to an embodiment of the present invention, a system for providing a marketplace to facilitate the sale and purchase of hotel reservations, the system comprising: reservation transaction handling module comprising computer executable code stored in non-volatile memory, a processor, a memory, and a communications means, wherein the reservation transaction handling module, the processor, the memory, and the communications means are operably connected and are configured to: receive a reservation listing request from a reservation holder, request reservation listing information from the reservation holder, wherein the reservation listing information is comprised of one or more of hotel name, reservation dates, reservation price, and reservation type, publish a reservation listing to the marketplace, wherein the marketplace comprises a plurality of reservation listings, receive a reservation listing selection from a reservation seeker, wherein the reservation listing is selected from the plurality of reservation listings, and confirm the reservation listing selection, wherein a confirmation is sent to both the reservation holder and the reservation seeker.

According to an embodiment of the present invention, the reservation transaction handling module, the processor, the memory, and the communications means are operably connected and are further configured to: collect a reservation payment from the reservation seeker, deduct a transaction fee from the reservation payment, and transfer remaining balance of the reservation payment to the reservation holder.

According to an embodiment of the present invention, the reservation transaction handling module, the processor, the memory, and the communications means are operably connected and are further configured to refund at least a portion of the reservation payment to the reservation seeker based on a cancellation policy.

According to an embodiment of the present invention, the reservation transaction handling module, the processor, the memory, and the communications means are operably connected and are further configured to: send a reservation approval request to the reservation holder, wherein the reservation holder is requested to submit a reservation confirmation regarding the reservation listing selection of the reservation seeker, receive the reservation confirmation from the reservation holder verifying whether the reservation holder has accepted the reservation selection of the reservation seeker, and send a reservation status verification to the reservation holder confirming whether the reservation selection has been accepted by the reservation holder.

According to an embodiment of the present invention, the reservation transaction handling module, the processor, the memory, and the communications means are operably connected and are further configured to: send a review feedback request to the reservation seeker and reservation holder, wherein the reservation seeker is requested to review reservation holder and reservation holder is requested to review reservation seeker and process the review feedback request to generate a marketplace rating for the reservation seeker and the reservation holder, wherein the marketplace rating is utilized by other reservation seekers and other reservation holders in the marketplace to evaluate possible future marketplace transactions with the reservation seeker and the reservation holder.

According to an embodiment of the present invention, the reservation transaction handling module, the processor, the memory, and the communications means are operably connected and are further configured to send a reservation update to a hotel, wherein an existing reservation held by the reservation holder is updated to include the reservation seeker on the existing reservation.

According to an embodiment of the present invention, the reservation type is selected from a group of reservation types including shared reservations and exclusive reservations.

According to an embodiment of the present invention, the reservation seeker can sort the reservation listings by one or more of the hotel name, the reservation dates, the reservation price, and the reservation type.

According to an embodiment of the present invention, a method for providing a marketplace to facilitate the sale and purchase of hotel reservations, the method comprising the steps of: receiving a reservation listing request from a reservation holder, requesting reservation listing information from the reservation holder, wherein the reservation listing information is comprised of one or more of hotel name, reservation dates, reservation price, and reservation type, publishing a reservation listing to the marketplace, wherein the marketplace comprises a plurality of reservation listings, receiving a reservation listing selection from a reservation seeker, wherein the reservation listing is selected from the plurality of reservation listings, confirming the reservation listing selection, wherein a confirmation is sent to both the reservation holder and the reservation seeker.

According to an embodiment of the present invention, the method further comprises the steps of: collecting a reservation payment from the reservation seeker, deducting a transaction fee from the reservation payment, and transferring remaining balance of the reservation payment to the reservation holder.

According to an embodiment of the present invention, the method further comprises the step of refunding at least a portion of the reservation payment to the reservation seeker based on a cancellation policy.

According to an embodiment of the present invention, the method further comprises the steps of: sending a reservation approval request to the reservation holder, wherein the reservation holder is requested to submit a reservation confirmation regarding the reservation listing selection of the reservation seeker, receiving the reservation confirmation from the reservation holder verifying whether the reservation holder has accepted the reservation selection of the reservation seeker, and sending a reservation status verification to the reservation holder confirming whether the reservation selection has been accepted by the reservation holder.

According to an embodiment of the present invention, the method further comprises the steps of: sending a review feedback request to the reservation seeker and reservation holder, wherein the reservation seeker is requested to review reservation holder and reservation holder is requested to review reservation seeker and processing the review feedback request to generate a marketplace rating for the reservation seeker and the reservation holder, wherein the marketplace rating is utilized by other reservation seekers and other reservation holders in the marketplace to evaluate possible future marketplace transactions with the reservation seeker and the reservation holder.

According to an embodiment of the present invention, the method further comprises the step of sending a reservation update to a hotel, wherein an existing reservation held by the reservation holder is updated to include the reservation seeker on the existing reservation.

According to an embodiment of the present invention, the method further comprises the step of sorting the reservation listings by one or more of the hotel name, the reservation dates, the reservation price, and the reservation type.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with embodiments of the present invention;

FIG. 2 illustrates a schematic overview of a network, in accordance with embodiments of the present invention;

FIG. 3 illustrates a schematic of a system for purchasing shared or exclusive hotel reservations, in accordance with embodiments of the present invention;

FIG. 4 is a process flow of an exemplary method for a Guest to book a reservation, in accordance with embodiments of the present invention;

FIG. 5 is a continuation of the method flow shown in FIG. 5, in accordance with embodiments of the present invention;

FIG. 6 is a process flow of an exemplary method for a Host to list a booking or reservation, in accordance with embodiments of the present invention; and

FIG. 7 is a continuation of the process flow shown in FIG. 7, in accordance with embodiments of the present invention.

### DETAILED DESCRIPTION OF THE INVENTION

The present invention relates to generally to an online marketplace. More specifically, the invention relates to an online marketplace where individuals are able to list bookings or shared accommodation and accept offers at the listing individual's discretion.

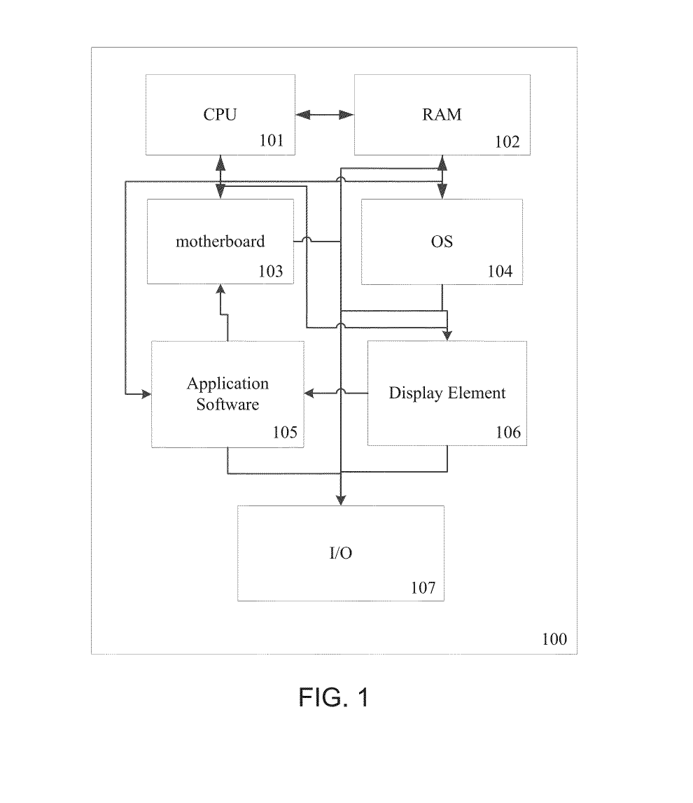

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, display element 106 and one or more input/output devices/means 107. Examples of computing devices usable with embodiments of the present invention include, but are not limited to, personal computers, smart phones, laptops, mobile computing devices and tablet PCs and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

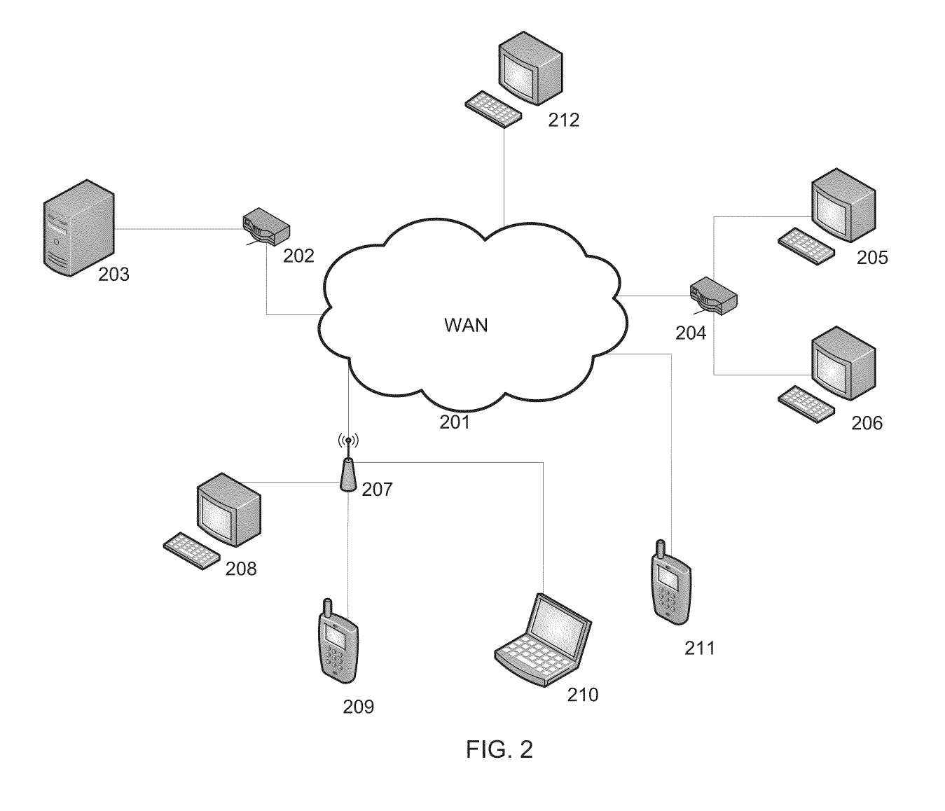

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

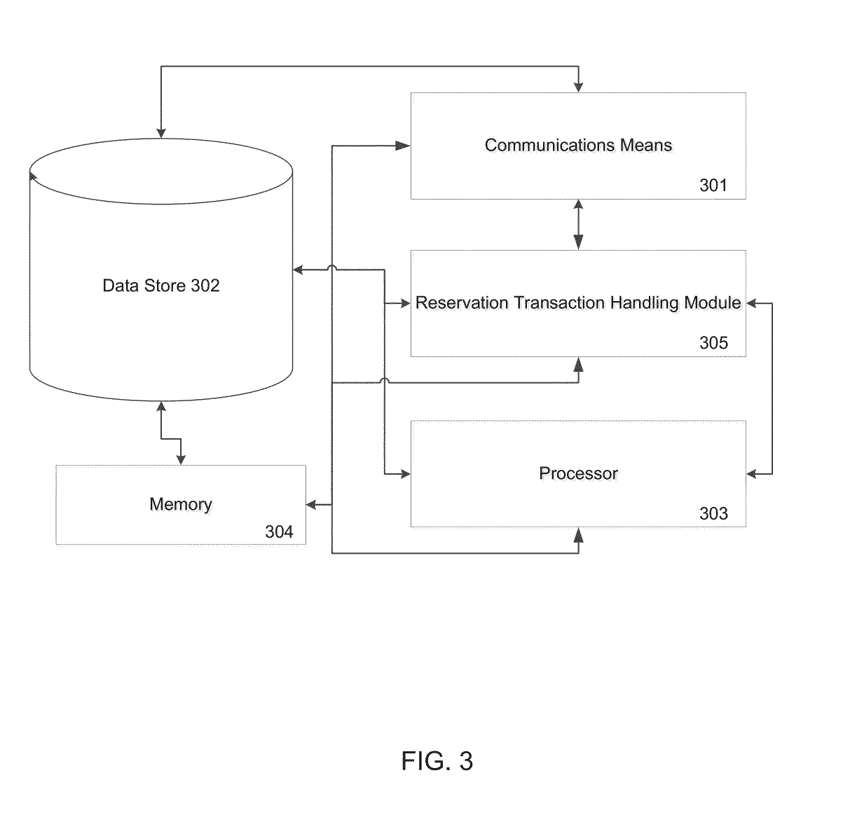

Turning to FIG. 3, according to an embodiment of the present invention, a system for sharing and selling reservations (and similar bookings) is comprised of one or more communications means 301, one or more data stores 302, a processor 303, memory 304, and a reservation transaction handling module 305. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data, voice or video communications over one or more networks or to one or more peripheral devices attached to the system. Appropriate communications means may include, but are not limited to, wireless connections, wired connections, cellular connections, data port connections, Bluetooth® connections, or any combination thereof. One of ordinary skill in the art would appreciate that there are numerous communications means that may be utilized with embodiments of the present invention, and embodiments of the present invention are contemplated for use with any communications means.

According to an embodiment of the present invention, a system and method are provided for a marketplace for selling and sharing reservations for travel accommodations. In a preferred embodiment, the system and method may be used to sell and share reservations for a hotel or similar lodging accommodations. In the preferred embodiment, a traveler listing a reservation (Hosts) can use an online marketplace to (i) sell their reservation for exclusive use by another traveler (Guest) or (ii) offer their reservation as a shared listing, where the Host shares the room with the Guest. One of ordinary skill in the art would appreciate that this system and method could be employed in any other industry where services are reserved or booked, and embodiments of the present invention are contemplated for use in any such industry.

According to an embodiment of the present invention, a user will be directed to read and accept the terms and conditions of the marketplace before listing a hotel reservation and becoming a Host. Once the user accepts the terms and conditions, the may be transferred to a page requesting that the user either (i) register and login or (ii) login through a third party platform (e.g. a social network, such as Facebook®). In the preferred embodiment, registering on the online marketplace will require the user's name, email address, and password. In some embodiments, additional information may be required such as credit card or other payment information. The registration information can be stored on the system and, at this point, the system can be configured to send the user a welcome email requesting that the user confirms their account. After a user confirms their account, a user is able to login and use the marketplace. In the preferred embodiment, the login process for new and existing users only requires a user's login and password to enter the online marketplace. When logging in via a social network (e.g. Facebook®), the online marketplace shows the login screen of the particular social network and, at this point, the Host enters their social network login and password. For users entering the site using a social network for the first time, the online marketplace may request access to some of their information such as profile information and user location for use in the online marketplace. One of ordinary skill in the art would appreciate there are many methods to facilitate a Host's registration and login to the marketplace, and embodiments of the present invention are contemplated for use with any such registration and login methods.

According to an embodiment of the present invention, once logged into the online marketplace, the Host is given two options for listing their hotel reservation. In a preferred embodiment, the Host can decide if they would like to share their room with a Guest from the marketplace or if they would like to offer the room on the marketplace as an exclusive listing for the private use of a Guest. In a preferred embodiment, once a decision is reached for listing the room (shared versus exclusive/private), the Host enters information regarding their listing. The information needed for listing a reservation may include, but is not limited to, hotel name, address, registration information, dates, price, refund policy, and Guest acceptance policy. In some embodiments, once the listing information has been entered, the online marketplace can use the hotel information to automatically pull up pictures for the room utilizing an RSS subscription service, an application program interface (API), or a similar protocol. When the listing has been finalized, the online marketplace then can send a confirmation message to the Host. When the Host confirms the listing, the system can request whether the Host would like to invite any of their friends. If the Host declines, they are taken to a home page. If the Host accepts, the online marketplace requests the Host's friends email address or other contact information and sends the selected friends an invitation. In the preferred embodiment, the system can then store the contact information within the database.

According to an embodiment of the present invention, Guests wishing to find a hotel reservation would search the online marketplace for listing by entering information that includes, but is not limited to, their desired check-in dates and city. In a preferred embodiment, available listings that match the Guests desired parameters are shown to the Guest with information about the hotel, including but not limited to, the price for the room, the type of listing (i.e. shared or exclusive), the Host's name, the refund policy for the room (i.e. flexible, moderate, or strict), and pictures of the room. Utilizing this information, the Guest can click “Book” to begin the booking process. One of ordinary skill in the art would appreciate that there are many parameters by which a Guest could search for a listing, and embodiments of the present invention are contemplated to incorporate any such search parameter.

According to an embodiment of the present invention, Guests “booking” a listing for the first time are directed to read and accept the terms and conditions for using the marketplace. In a preferred embodiment, once the terms and conditions have been accepted, Guests are then transferred to a page requesting that they either (i) register and login or (ii) login through a third party platform (e.g. a social network, such as Facebook®). In the preferred embodiment, registering on the online marketplace will require the user's name, email address, and password. In some embodiments, additional information may be required such as credit card or other payment information. The registration information can be stored on the system and, at this point, the system can be configured to send the user a welcome email requesting that the user confirms their account. After a user confirms their account, a user is able to login and use the marketplace. In the preferred embodiment, the login process for new and existing users only requires a user's login and password to enter the online marketplace. When logging in via a social network (e.g. Facebook®), the online marketplace shows the login screen of the particular social network and, at this point, the Host enters their social network login and password. For users entering the site using a social network for the first time, the online marketplace requests access to some of their information such as profile information and user location for use in the online marketplace. One of ordinary skill in the art would appreciate there are many methods to facilitate a Guest's registration and login to the marketplace, and embodiments of the present invention are contemplated for use with any such registration and login methods.

According to an embodiment of the present invention, the Host can elect whether to approve a booking request submitted by a Guest or to automatically accept the booking request. In a preferred embodiment, when the system determines that the Host has requested to approve the Guest prior to accepting the booking, an email or similar message (e.g. text message) is sent to Host with the Guest's information when a book request is submitted. If the Host declines the Guest's booking, then the system sends the Guest a notification that informs them that the booking request was declined and offers them to search for another listing. If the Host does not require approval or if the Host required approval and approves the Guest, then the Guest is presented with a way to input their preferred payment option in order to finalize the booking request. Once a payment option is selected, the system stores the information about the transaction and contacts the hotel via fax or email requesting them to add the Guest to the reservation's guest-list. At this point, the system sends an email with the itinerary to the Guest and an email notifying the Host about the changes made to their reservation. One of ordinary skill in the art would appreciate that there many methods to carry out the approval process, and embodiments of the present invention are contemplated for use with any such approval process.

According to an embodiment of the present invention, the online marketplace may be configured to communicate with a third party system regarding the details and status of the reservation. In a preferred embodiment, the online marketplace may contact the third party (i.e. a hotel) via fax, email, or through an API. In the preferred embodiment, the marketplace can be configured to contact the hotel or similar third party to update the reservation. As an illustrative example, when the listing that the Guest has purchased is an exclusive listing, the marketplace may be configured to automatically contact the hotel to update the name on the reservation by changing the name from the Host's name to the Guest's name. Likewise, when listing that the Guest has purchase is a shared listing, the marketplace may be configured to automatically contact the hotel to update the reservation to add the Guest's name to the reservation. Similarly the marketplace could be configured to provide other updates to the hotel, including the contact information of the Guest, payment information (e.g. for the payment of incidental charges), and check-in information. By providing the contact information of the Guest, the hotel would be able to communicate directly with the Guest regarding any relevant information about the reservation including check-in times, room ready notifications, directions to the hotel, and similar information. One of ordinary skill in the art would appreciate that there are many useful functions that could be provided by a direct link between the marketplace system and the hotel itself, and embodiments of the present invention re contemplated to take advantage of any such function.

According to an embodiment of the present invention, the system is setup to automatically process transactions from Guests. In a preferred embodiment, when a Guest's booking request is accepted, the system stores the transaction details until the check-in date. Then, on the check-in day, the Guest may be required to show identification to check into the hotel. When the Guest checks in, the systems pulls up the transaction data and removes funds from the Guest's account and transfers the funds to an escrow account. If the Guest does not cancel his reservation and does not check-in to hotel in accordance with his reservation, the Guest loses the money paid for the reservation. In a preferred embodiment, money paid by Guests will be transferred from the escrow account to the Host after deducting the administration costs for the marketplace. In an alternate embodiment, funds may be paid directly to the Host upon approval of the booking request by the Host. In another alternate embodiment, the marketplace system may be configured to provide the Guest's payment information to the hotel so that the hotel can charge the Guest accordingly at check-in, thereby transferring the responsibility for payment from the Host to the Guest. One of ordinary skill in the art would appreciate that there are many methods to initiate or transfer payment obligations, and embodiments of the present invention are contemplated with any such method.

According to an embodiment of the present invention, the marketplace system may be configured to collect a marketplace administration fee for the Host's use of the marketplace. In a preferred embodiment, once the Guest completes their stay and checks out, the system removes the funds from the escrow account and deducts a percentage (e.g. 15%) of the funds as a transaction fee and sends the remaining balance to the Host's account. At this point, the system sends an email to both Host and Guest requesting that they rate each other. In an alternate embodiment, as discussed above, payment may be made directly to the Host immediately following the Host's approval of the Guest's booking request. In such an embodiment, the administration fee could be automatically calculated and deducted simultaneously when the payment is transferred to the Host. One of ordinary skill in the art would appreciate that there are many methods by which the administration fee could be collected, and embodiment of the present invention are contemplated for use with any such administration fee calculation and collection method.

According to an embodiment of the present invention, the marketplace may be configured to administer a refund policy. In a preferred embodiment, there are three refund policies that a Host can set for processing a cancellation, which are, flexible, moderate, or strict. In the preferred embodiment, the flexible refund policy allows Guests to cancel their reservation at any point but subtracts a transaction fee (e.g. 15%) from the Guest's account. The moderate refund policy allows Guests cancel five days in advance of their check-in date and receive a full refund minus the 15% transaction fee. The strict refund policy allows Guest to cancel five days in advance of their check-in date but only refunds 50% of the cost for the reservation, while the remaining 50% is transferred to the Host after deducting 15% of the original value of the funds. These examples represent an assortment of possible cancellation policies and the cancellation policy that is actually implemented could be varied based upon any number of factors. One of ordinary skill in the art would appreciate that the marketplace system could be configured to apply any refund policy, and embodiments of the present invention are contemplated for use with any such refund policy.

According to an embodiment of, the system providing the marketplace may be configured to offer a feedback and review system. In a preferred embodiment, the feedback and review system may be used by both Hosts and Guests to facilitate decisions about sharing and purchasing reservations. In some embodiments, the marketplace may be further configured to integrate with social networking sites to enhance or supplement the feedback and review aspect of the system. In the preferred embodiment, before sending a booking request for a particular listing, a Guest can read reviews for the Host. The reviews would be provided by Guests who have previously accepted and completed offers with the Host. Additionally, if the Host has associated their marketplace account with a social networking site, a Guest can use the Host's online profile to aid the Guest in their decision making process. Conversely, when a Host receives a booking request, the Host can use submitted reviews and, if available, the social network profile of the given Guest to influence the Host's decision of whether or not to accept the booking request. One of ordinary skill in the art would appreciate that there are many benefits and features that could be incorporated into a review and feedback system, and embodiments of the present invention are contemplated to take advantage of any such benefits and features.

According to an embodiment of the present invention, the systems and methods described herein that provide the marketplace for the sharing and selling of reservations may be implemented through the use of a reservation transaction handling module. In a preferred embodiment, the reservation transaction handling module is configured to facilitate the sharing or sale of a reservation (or similar booking) between a first party (e.g. reservation holder or Host) that holds the reservation and a second party (e.g. reservation seeker or Guest) that needs a reservation. In a preferred embodiment, the reservation transaction handling module facilitates the purchase and sale of via an online marketplace. The reservations that are purchased and sold through the marketplace are typically existing reservations that are already being held by the first party. The first party holding the reservation may wish to sell their reservation to or share their reservation with a second party and the reservation transaction handling module is used to implement a marketplace to facilitate such an exchange.

According to a preferred embodiment of the present invention, the reservation transaction handling module provides a marketplace for the sale and purchase of hotel reservations by publishing a reservation listing received from reservation holder (or Host), receiving a reservation selection from a reservation seeker (or Guest), and providing a process by which the reservation seeker's selection can be approved and confirmed by a reservation holder. In alternate embodiments, the reservation transaction handling module may be configured to facilitate additional or fewer functions. For example, the reservation transaction handling module can be configured to automatically confirm a reservation selection from a Guest or to request the Host's approval before confirming the reservation selection. Additionally, the reservation transaction handling module can be configured to management payment and refund functions, as well as a feedback and review system. One of ordinary skill in the art would appreciate that a reservation transaction handling module could be configured to accomplish a variety of tasks, and embodiments of the present invention are contemplated for use with any such task.

### Exemplary Embodiments

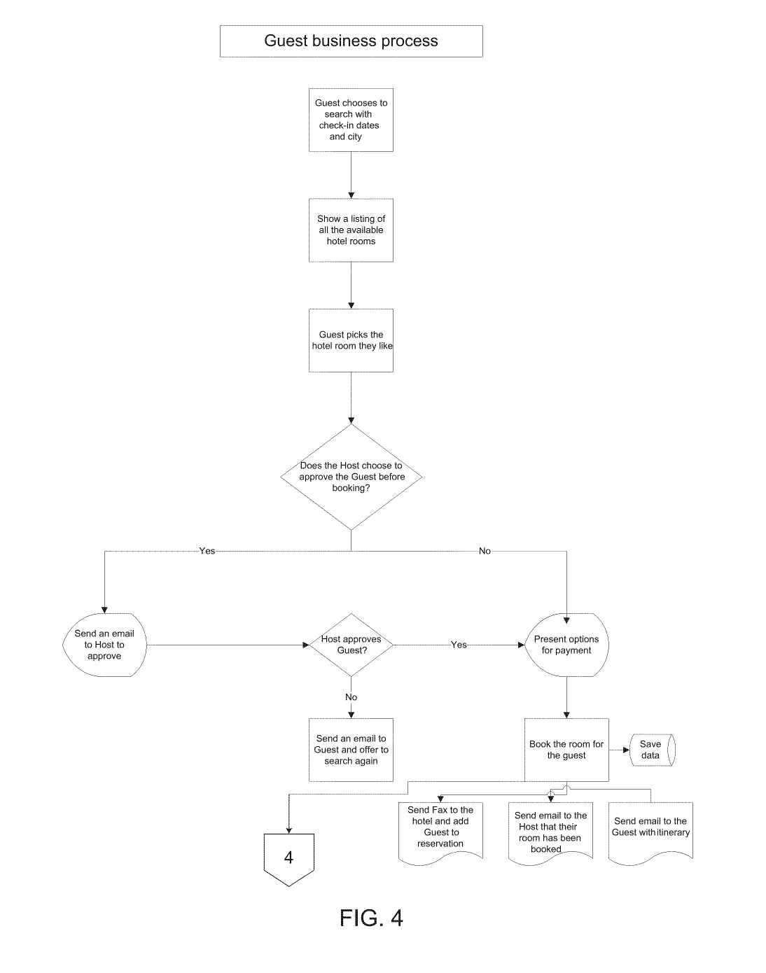

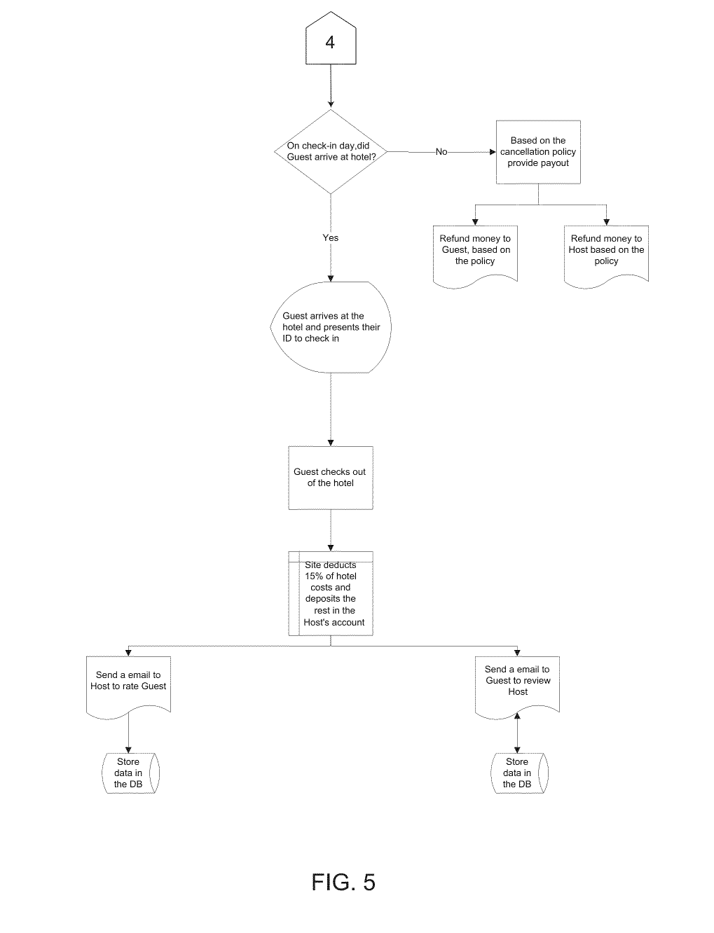

Turning now to FIGS. 4 and 5, an exemplary method of using the hotel reservation marketplace from the perspective of a Guest in accordance with an embodiment of the present invention. As shown in FIG. 4, the Guest will be prompted to search the available reservation listings according to a variety of parameters including, but not limited to, city, check-in/check-out dates, cost, and listing type. A subset of reservation listings that match the Guest selected preferences will then be presented to the Guest, at which point the Guest may select a specific reservation listing for booking. At this point the reservation selection may either be automatically confirmed or be held for approval by the Host before a final confirmation is sent to the Guest. Once confirmation has been finalized, the reservation will be booked for the Guest. Depending on the type of listing, the reservation with the hotel will either be changed to the name of the Guest (in the case of an exclusive listing) or updated to include the name of the Guest (in the case of a shared listing). As shown in FIG. 5, the reservation marketplace may also facilitate payment and refund functions, as well as a feedback review system.

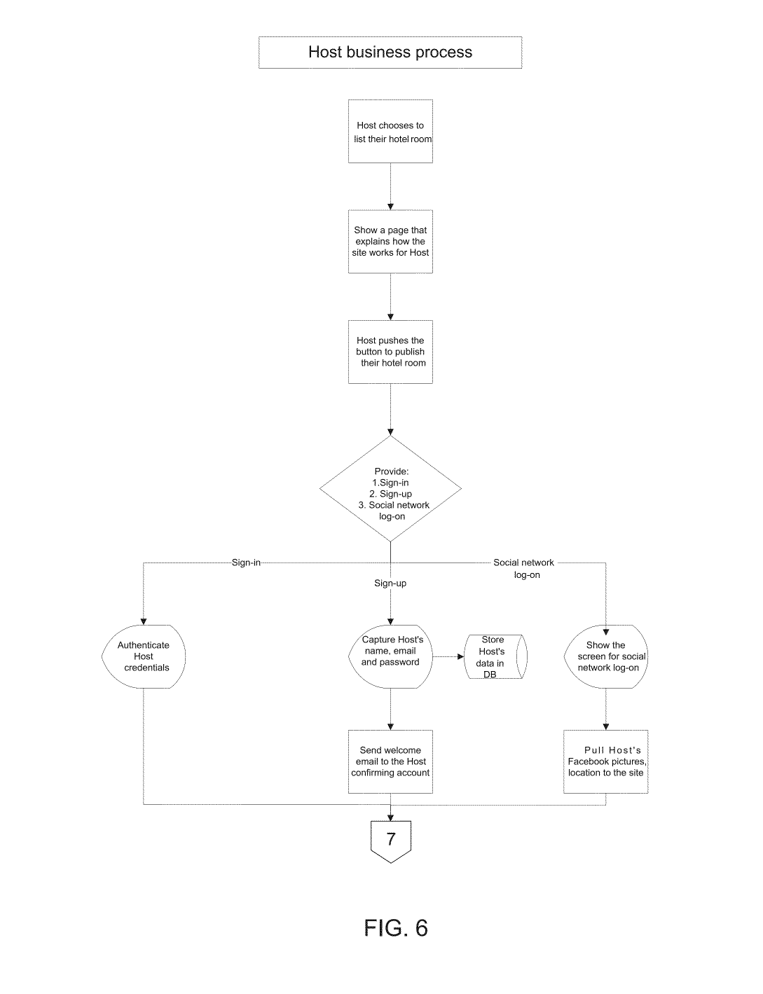

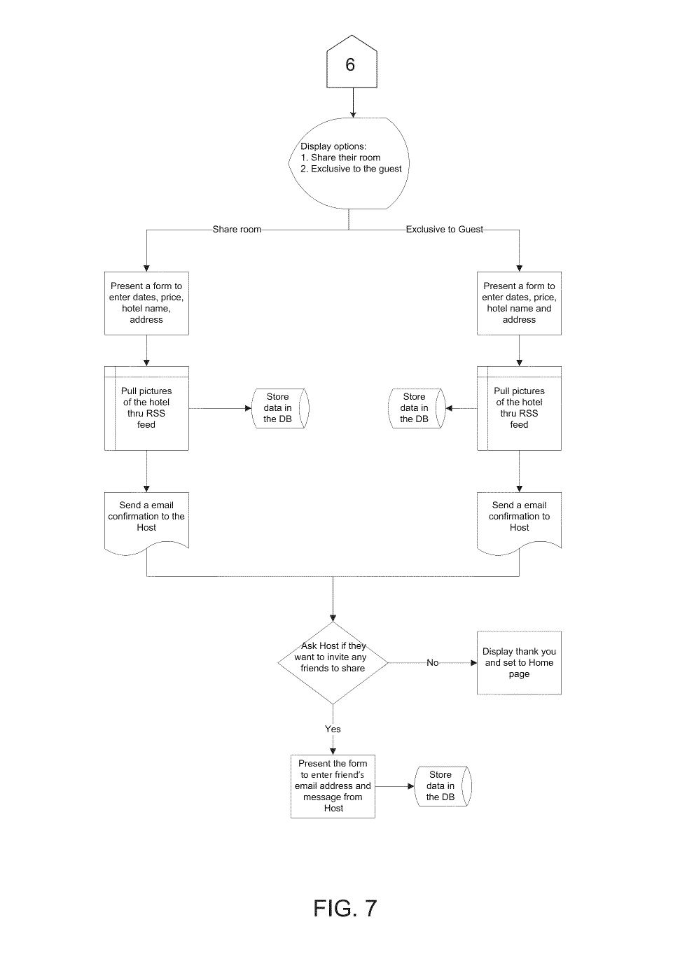

Turning now to FIGS. 6 and 7, an exemplary method of using the hotel reservation marketplace from the perspective of a Host in accordance with an embodiment of the present invention. As shown in FIG. 6, the Host will first be requested to sign-up or logon to the online marketplace. As shown in FIG. 7, after logging into the marketplace, the Host will be guided through preparing a reservation listing. The Host may be requested to provide various reservation listing information including, but not limited to, the name of the hotel, the dates of the reservation, the cost of the reservation, and the listing type (which is whether the listing is an offer for a shared reservation or an exclusive reservation). The Host may also be prompted to share the reservation listing with the Host's friends.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. There may be aspects of this invention that may be practiced without the implementation of some features as they are described. It should be understood that some details have not been described in detail in order to not unnecessarily obscure focus of the invention. The invention is capable of myriad modifications in various obvious aspects, all without departing from the spirit and scope of the present invention. Accordingly, the drawings and descriptions are to be regarded as illustrative in nature and not restrictive.

1. A system for providing a marketplace to facilitate the sale and purchase of hotel reservations, the system comprising:
a reservation transaction handling module comprising computer executable code stored in non-volatile memory;
a processor;
a memory;
and a communications means,
wherein said reservation transaction handling module, said processor, said memory, and said communications means are operably connected and are configured to:
receive a reservation listing request from a reservation holder;
request reservation listing information from said reservation holder, wherein said reservation listing information is comprised of one or more of hotel name, reservation dates, reservation price, and reservation type;
publish a reservation listing to said marketplace, wherein said marketplace comprises a plurality of reservation listings;
receive a reservation listing selection from a reservation seeker, wherein said reservation listing is selected from said plurality of reservation listings; and
confirm said reservation listing selection, wherein a confirmation is sent to both said reservation holder and said reservation seeker.

2. The system of claim 1, wherein said reservation transaction handling module, said processor, said memory, and said communications means are operably connected and are further configured to:
collect a reservation payment from said reservation seeker;
deduct a transaction fee from said reservation payment; and
transfer remaining balance of said reservation payment to said reservation holder.

3. The system of claim 2, wherein said reservation transaction handling module, said processor, said memory, and said communications means are operably connected and are further configured to refund at least a portion of said reservation payment to said reservation seeker based on a cancellation policy.

4. The system of claim 1, wherein said reservation transaction handling module, said processor, said memory, and said communications means are operably connected and are further configured to:
send a reservation approval request to said reservation holder, wherein said reservation holder is requested to submit a reservation confirmation regarding said reservation listing selection of said reservation seeker;
receive said reservation confirmation from said reservation holder verifying whether said reservation holder has accepted said reservation selection of said reservation seeker; and
send a reservation status verification to said reservation holder confirming whether said reservation selection has been accepted by said reservation holder.

5. The system of claim 1, wherein said reservation transaction handling module, said processor, said memory, and said communications means are operably connected and are further configured to:
send a review feedback request to said reservation seeker and reservation holder, wherein said reservation seeker is requested to review reservation holder and reservation holder is requested to review reservation seeker; and
process said review feedback request to generate a marketplace rating for said reservation seeker and said reservation holder, wherein said marketplace rating is utilized by other reservation seekers and other reservation holders in said marketplace to evaluate possible future marketplace transactions with said reservation seeker and said reservation holder.

6. The system of claim 1, wherein said reservation transaction handling module, said processor, said memory, and said communications means are operably connected and are further configured to send a reservation update to a hotel, wherein an existing reservation held by said reservation holder is updated to include said reservation seeker on said existing reservation.

7. The system of claim 1, wherein said reservation type is selected from a group of reservation types including shared reservations and exclusive reservations.

8. The system of claim 1, wherein said reservation seeker can sort said reservation listings by one or more of said hotel name, said reservation dates, said reservation price, and said reservation type.

9. A method for providing a marketplace to facilitate the sale and purchase of hotel reservations, the method comprising the steps of:
receiving a reservation listing request from a reservation holder;
requesting reservation listing information from said reservation holder, wherein said reservation listing information is comprised of one or more of hotel name, reservation dates, reservation price, and reservation type;
publishing a reservation listing to said marketplace, wherein said marketplace comprises a plurality of reservation listings;
receiving a reservation listing selection from a reservation seeker, wherein said reservation listing is selected from said plurality of reservation listings; and
confirming said reservation listing selection, wherein a confirmation is sent to both said reservation holder and said reservation seeker.

10. The method of claim 9, further comprising the steps of:
collecting a reservation payment from said reservation seeker;
deducting a transaction fee from said reservation payment; and
transferring remaining balance of said reservation payment to said reservation holder.

11. The method of claim 10, further comprising the step of refunding at least a portion of said reservation payment to said reservation seeker based on a cancellation policy.

12. The method of claim 9, further comprising the steps of:
sending a reservation approval request to said reservation holder, wherein said reservation holder is requested to submit a reservation confirmation regarding said reservation listing selection of said reservation seeker;
receiving said reservation confirmation from said reservation holder verifying whether said reservation holder has accepted said reservation selection of said reservation seeker; and
sending a reservation status verification to said reservation holder confirming whether said reservation selection has been accepted by said reservation holder.

13. The method of claim 9, further comprising the steps of:
sending a review feedback request to said reservation seeker and reservation holder, wherein said reservation seeker is requested to review reservation holder and reservation holder is requested to review reservation seeker; and
processing said review feedback request to generate a marketplace rating for said reservation seeker and said reservation holder, wherein said marketplace rating is utilized by other reservation seekers and other reservation holders in said marketplace to evaluate possible future marketplace transactions with said reservation seeker and said reservation holder.

14. The method of claim 9, further comprising the step of sending a reservation update to a hotel, wherein an existing reservation held by said reservation holder is updated to include said reservation seeker on said existing reservation.

15. The method of claim 9, wherein said reservation type is selected from a group of reservation types including shared reservations and exclusive reservations.

16. The method of claim 9, further comprising the step of sorting said reservation listings by one or more of said hotel name, said reservation dates, said reservation price, and said reservation type.
